(19) United States
(12) Patent Application Publication
(10) Pub. No.: US 2009/0054238 A1
(43) Pub. Date: Feb. 26, 2009

(54) PREPARATION CONTAINING A PHOTOCATALYTICALLY ACTIVE METAL OXIDE POWDER AND A WETTING AGENT

(75) Inventors: Ingo Fleute-Schlachter, Essen (DE); Ewald Sieverding, St. Johann (DE); Wolfgang Lortz, Waechtersbach (DE); Jochen Scheffler, Alzenau (DE); Kai Schumacher, Hofheim (DE); Reinhard Vormberg, Neuberg (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK DEGUSSA GmbH, Essen (DE)

(21) Appl. No.: 11/996,658

(22) PCT Filed: Jun. 29, 2006
(86) PCT No.: PCT/EP06/63696

§ 371 Date: Jul. 24, 2008

(30) Foreign Application Priority Data
Jul. 28, 2005 (DE) 10 2005 035 311.8

(51) Int. Cl. A01N 59/16; A01P 13/00; B01J 23/00; B01J 21/06

(52) U.S. Cl. 504/187; 502/300; 502/350; 502/343; 502/242; 502/158

(57) ABSTRACT

Preparation containing at least one photocatalytically active metal oxide powder with a specific surface area of at least 20 m²/g at least one wetting agent. Use of the preparation for weed control.

The invention relates to a preparation which contains photocatalytically active metal oxide powder and a wetting agent. The invention further relates to the production and use of the preparation as a herbicide.

From EP-A-1216616, a preparation is known which contains a photocatalytically active substance. A preferred photocatalytically active substance is titanium dioxide, which can be incorporated into the preparation as a powder or sol. The preparation is sprayed onto the foliage of plants which are at an underdeveloped stage owing to a lack of sunlight. The preparation acts as a growth promoter and should at the same time effectively help prevent plant diseases. The mode of action of the preparation is based on the fact that the photocatalytic decomposition of water on the surface of the foliage is accelerated and as a result the assimilation of carbon dioxide is promoted. Moreover, oxygen free radicals, such as are formed during the photocatalytic decomposition of water, promote the formation of the plant hormone ethylene, important for plant growth. Further, according to EP-A-1216616, the formation of phytoalexin, which can decompose herbicides adhering to the foliage, is stimulated.

From WO98/38848, it is known that finely divided, inert, reflecting particles can be used in order to increase photosynthesis in garden plants. As suitable particles, inter alia titanium dioxide particles are mentioned.

From WO 03/070002, a method for weed control is known, wherein hydrophobic, inert solids with a mean particle size of less than 100 μm are incorporated into the soil at a depth of at least 1 cm. The hydrophobic solids can be incorporated as a finely divided powder, as a dispersion or as an emulsion. They are hydrophobic as such or acquire a hydrophobic surface through reaction with suitable coupling agents, such as silanes and fatty acids. For example, the hydrophobic solid can be titanium dioxide, which is inert when used in the soil according to the invention.

From the state of the technology, it follows that finely divided particles are suitable for stimulating the photo-synthesis of plants if these particles are applied to above-ground parts of the plants. Further, it follows from the state of the technology that certain finely divided particles incorporated into the soil can be used for weed control.

The purpose of the present invention is to provide a preparation for weed control which is applied onto the above-ground parts of the plants.

The purpose is surprisingly achieved by means of a preparation which contains at least one photocatalytically active metal powder, wherein the specific surface area of the metal oxide powder is at least 20 m²/g and the preparation contains at least one wetting agent.

A photocatalytically active metal oxide powder should be understood to mean a metal oxide powder which contains crystalline components, and is preferably completely crystalline, wherein the crystalline components are capable of absorbing quanta of light, as a result whereof an electron is promoted from the valence band of the metal oxide into the conducting band. If the free electrons migrate to the surface, they can trigger reactions there. The metal oxide powder is then photocatalytically active.

The specific surface area of the metal oxide powder, determined as per DIN 66131, is at least 20 m²/g. Below 20 m²/g, the activity as a herbicide is too low. Preferably the preparation according to the invention contains metal oxide powder with a specific surface area of 40 to 100 m²/g. Metal oxide powders with specific surface areas of 200 to 300 m²/g can also be used. However, these metal oxide powders only show the same or only slightly higher activity than metal oxide powders with a specific surface area of 40 to 100 m²/g.

Wetting agents in the sense of the invention should be understood to mean those which decrease the surface tension of water to values below 35 mN/m.

The liquid phase of the preparation according to the invention can be aqueous, that is, the main component is water. The liquid phase can also be organic, the main component being an organic compound.

The content of photocatalytically active metal oxide powder and wetting agents of the preparation according to the invention is preferably in each case 0.001 to 70 wt. %, based on the preparation, wherein the contents of photocatalytically active metal oxide powder and wetting agent are mutually independent.

For the transportation of the preparation according to the invention, in order to save costs, as high as possible a content of photocatalytically active metal oxide powder and wetting agent will be preferred. In particular, it is advantageous if for this purpose the content of photocatalytically active metal oxide powder is 25 to 50 wt. %. In this range, metal oxide dispersions as a rule still display adequate stability against sedimentation and/or reagglomeration auf.

For the use of the preparation for weed control, however, as low as possible a content of photocatalytically active metal oxide powder and wetting agent is the aim. Preferable for this is a preparation according to the invention with a content of 0.02 to 5 wt. % of photocatalytically active metal oxide powder and from 0.001 to 2.0 wt. % of wetting agent, and concentrations in the range of 0.02 to 1% of metal oxide powder and 0.01 to 0.5% of a wetting agent are particularly advantageous.

Further, it can be advantageous when the mean particle diameter of the photocatalytically active metal oxide powder in the preparation is smaller than 1000 nm. A mean particle diameter of less than 200 nm is particularly advantageous. With these values, the treated parts of the plants appear extremely or completely transparent. Further, the efficacy of the weed control is particularly high.

The photocatalytically active metal oxide powders present in the preparation according to the invention can be present in aggregated, partly aggregated or non-aggregated form. Surprisingly, aggregated powders have been found to be particularly active.

Moreover, photocatalytically active metal oxide powders which have no internal surface have been found to be particularly active.

The photocatalytically active metal oxide powder can preferably be a titanium dioxide powder, a zinc oxide powder, a mixed oxide powder with the components Ti, Zn, Zr, Al and/or Si, a crystal lattice-doped titanium dioxide powder or zinc oxide powder, in particular doped with C, N, Pt or W, a surface-modified titanium dioxide- or zinc oxide powder or a mixture of the aforesaid compounds. The surface modification can be of an inorganic nature, for example the oxides of silicon, aluminium or zirconium. The surface modification can also be of an organic nature, i.e. for example modification with fatty acids such as stearates or organic silanes.

Further, with the preparation according to the invention which contains titanium dioxide powder, it is advantageous when this has a rutile and anatase phase. In this the anatase form should predominate. A rutile/anatase ratio of 30/70 to 10/90 is suitable. In rutile, the gap between valence and conduction band is about 3.05 eV, corresponding to an absorption at 420 nm, in anatase the gap is 3.20 eV, corresponding to an absorption at 385 nm. As a result, the rutile component can pass absorbed quanta on to the anatase system and thus increase the probability of photocatalytic processes.

Particularly advantageous is a preparation according to the invention wherein the photochemically active metal oxide powder can be obtained by flame hydrolysis or flame oxidation. In flame oxidation, a metal oxide precursor or a mixture of metal oxide precursors is oxidised with oxygen with the formation of the metal oxide or metal mixed oxide powder. In flame hydrolysis, the formation of the metal oxide or metal mixed oxide powder takes place by hydrolysis of the metal oxide precursor or precursors, the water necessary for the hydrolysis being derived from the combustion of a fuel gas, for example hydrogen, and oxygen. By way of example, the equations 1a and 1b describe the formation of titanium dioxide via flame oxidation (Eq.1 a) and flame hydrolysis (Eq. 1b).

TiCl₄+O₂−>TiO₂+2Cl₂ (Eq. 1a)

TiCl₄+2H₂O−>TiO₂+4HCl (Eq. 1b)

Particularly advantageous is a preparation according to the invention, wherein the photochemically active metal oxide powder contains titanium dioxide or consists thereof and was produced by flame hydrolysis.

In particular, this can be a titanium dioxide powder which has a specific surface area (BET surface area) of 20 to 200 m²/g and a primary particle distribution half-value width HW between HW [nm]=a×BET^{f} with a=670×10⁻⁹ m³/g and −1.3≦f≦−1.0 and wherein the content of particles with a diameter of more than 45 μm lies in a range from 0.0001 to 0.05 wt. %.

Preferably, the titanium dioxide powders can be TiO₂−1 and TiO₂−2 with the following characteristics;

| | | TiO₂-1 | TiO₂-2 |
|---|---|---|---|
| Specific surface area | m²/g | 40-60 | 80-120 |
| Primary particle diameter* | nm | 10-40 | 4-25 |
| Equivalent circular diameter | nm | <80 | <70 |
| (ECD) of aggregates | | | |
| Mean aggregate area | nm² | <6500 | <6000 |
| Mean aggregate size | nm | <450 | <400 |

| | | |
|---|---|---|
| Aggregates/agglomerates > 45 μm | wt. % | 0.002-0.005 |
| Rutile/anatase | | 20:80-5:95 |

*90% range, numerical distribution

These powders and the production thereof are described in the still unpublished German patent application with the application number 102004055165.0 and the application date 16 Nov. 2004.

As well as the UV light-absorbing metal oxide powder, the preparation according to the invention contains as an essential component at least one wetting agent.

Preferably, the preparation according to the invention can contain wetting agents from the chemical classes of the sulphosuccinates such as Rewopol SB DO 75, amphoteric surfactants such as betaines (Tego Betain F50) or amine oxides (Aminoxid WS 35), ethoxylated alcohols such as Tego Alkanol TD-6, ethoxylated fatty acids such as Rewopal EO 70, sorbitan esters such as Tego SML, ethoxylated sorbitan esters such as Tego SMO 80V, alkylpolyglucosides such as Tegotens G 826, and ethoxylated glyceryl esters such as Tagat V20.

Particularly preferably, the preparation according to the invention can contain superspreading agents as wetting agents. These are characterized in that in aqueous solutions at a concentration of 0.1% or less they form a thin film on a hydrophobic surface within seconds (S. Zhu et. Al. In Colloids Surfaces A: Physicochem. Eng. Aspects, 1994, 63-78). Hydrophobic surfaces should be understood to be for example leaves and plants which are used agriculturally and horticulturally or harvested products therefrom.

Particularly preferably, the preparation according to the invention can contain polyether-modified polysiloxanes, polyether-modified silane surfactants or fluoro surfactants as superspreading agents.

In particular these can be polysiloxanes of the general formula

R₃—Si—[OSiRR¹]ₙ—O—SiR₃

wherein

R is an alkyl residue with 1 to 6 carbon atoms,

R¹ has the structure —Z—O—R² and Z is an optionally branched alkylene residue with 2 to 6 carbon atoms in the alkylene chain,

R² a residue of the formula (CₘH₂ₘO—)ₛR³, wherein m is a number>2.0 and ≦2.5, s a number from 4 to 21 and R³ a hydrogen residue, an alkyl residue with 1 to 4 carbon atoms or an acetyl residue, and

n is a number from 1 to 4.

Suitable, commercially available superspreading agents can be:

Sylgard® 309 from Dow Corning, MI, USA, a polyether-modified trisiloxane surfactant, wherein the polyether is built up only of units of ethylene oxide (EO) and this has an acetyl termination.

Silwet® L-77 from GE/OSi, CT, USA, a polyether-modified trisiloxane surfactant, wherein the polyether is built up only of units of EO, this has a methyl end closure

Silwet® 408 from GE/OSi, CT, USA, a polyether-modified trisiloxane surfactant, wherein the polyether is built up only of units of EO,

BREAK-THRU® 240 from Goldschmidt GmbH, Germany, a polyether-modified trisiloxane surfactant, wherein the polyether is built up of units of ethylene- and propylene oxide

Bayowet® FT 248 from Lanxess AG, Germany, a fluoro surfactant based on tetraethylammonium heptadecafluor-octanesulphonate.

Furthermore, the preparation according to the invention can contain additives, such as are known to the skilled person for the stabilization of dispersions against sedimentation or reagglomeration. These can for example be pH regulators such as carboxylic acids, dicarboxylic acids, hydroxy-carboxylic acids or mineral acids and/or salts thereof. Further, the preparation according to the invention can contain phosphates, polyphosphates, poly-acrylic acids and salts thereof, cationic polymers, and/or amino alcohols.

A further object of the invention is a process for the production of the preparation according to the invention wherein
a dispersion with a photocatalytically active metal oxide powder content of up to 75 wt. %, which optionally can be stabilized by addition of pH regulators or surfactant substances,
is added with stirring to a polyether organopoly-siloxane and optionally water, until the desired content of metal oxide powder and wetting agent is in the range from 0.001 to 70 wt. %.

A further object of the invention is the use of the preparation according to the invention for weed control.

### EXAMPLES

Preparations

The titanium dioxide dispersion (I) has a titanium dioxide content of 35 wt. %. Furthermore, it contains 21 wt. % of a polyacrylic acid and 46 wt. % of water.

The titanium dioxide used is a pyrogenically produced, aggregated titanium dioxide powder with a specific surface area of 50 m²/g.

As the wetting agent, BREAK-THRU© S 240, Goldschmidt GmbH, is used.

Mode of action of the wetting agent: one drop of 50 μl of a preparation according to the invention, which contains 1% (w/w) of metal oxide and 0.1% (w/w)of BREAK-THRU© S 240 spreads on all sides on a hydrophobic surface (PE film) and evenly covers a circular area with a diameter of 6-8 cm.

Preparation A: 1 kg of the titanium dioxide dispersion (I) is dispersed in 100 kg of water. Next, BREAK-THRU© S240 is added (0.041 wt. %).

Preparation B: 0.5 kg of the titanium dioxide dispersion (I) are dispersed in 100 kg of water. Next, BREAK-THRU© S240 is added (0.041 wt. %).

### Example 1

Greenhouse Trial

Beans were used as representatives of broad-leaved plants (dicotyledons) and barley as a representative of the grass-like monocotyledons.

Preparation A was sprayed onto potted barley plants and bean plants which were in the 2-4 leaf development state. 10 pots with several plants are placed on one surface for the spraying. Using a spray boom, 30 ml of preparation A per m² were sprayed onto the plants with a nozzle from a distance of 40 cm. After this, the plants were exposed under controlled conditions to a UV-B radiation dose. For the beans this corresponded to 0.07 kW/m², administered over a period of 8 hours, and for barley a dose of 0.088 kW/m² (administered over a period of 10 hours).

The biological effects caused by UV-B sunburn were scored 24 hours after the irradiation. For this, the maximum damage was assessed with the score 3 (extremely severely damaged plants) and the value 0 was awarded when the plants were not damaged.

It was surprisingly found that the preparation A according to the invention showed severe damaging effects on beans and barley when the plants had been treated with UV-B radiation.

TABLE 1
Greenhouse Trial - Scores* for UV-induced
damage after 24 hrs treatment

| | | |
|---|---|---|
| Beans | preparation A | 2.75 |
| | not treated | 2.075 |
| Barley | preparation A | 2.50 |
| | not treated | 2.25 |

*0 = no damage, 1 = mild, 2 = moderate, 3 = extremely severe damage, plants almost dead

In the model plants beans and barley, an intensification of the damaging action of UV-B rays in the presence of the preparation according to the invention was observed, which can be described as herbicidal action and herbicidal action intensification. Thus the herbicidal action is of a general nature. It can however vary in magnitude from plant species to plant species.

### Example 2

### Field Trial

The field trial was performed with the winter barley variety “Carrero” in Orsingen-Nenzingen, Baden-Württemberg, Germany. The plants were sprayed once with the preparations A and B at growth stage 39:

For this, 300 l pro ha were sprayed each time in 4 repeated plots in the field with nozzles. There were also untreated plots. 2 and 4 weeks after the treatment, the whole plots (whole plant stand) were scored for brown-red necroses which were caused by sunburn; after the 4-week treatment, the flag leaf (top leaf of the barley plant) was examined for diseases and the net blotch disease found was scored as percentage leaf area infected.

TABLE 2
Open land trial - Necrotic areas* and net blotches** in barley

| | |
|---|---|
| Necrotic | Net blotches |
| area (%) | (%) |

| Treatment | 2 WAP | 4 WAP | 4 WAP |
|---|---|---|---|
| Untreated | 4 c^{($)} | 90 a | 18 a |
| Preparation B | 13 b | 89 a | 14 a |
| Preparation A | 22 a | 91 a | 18 a |

*Proportion of damaged, necrosed parts of the whole barley stand (%) at 2 and 4 weeks (2 WAP and 4 WAP) after the treatment;
**Infection of the flag leaf with net blotch disease at 4 weeks after the treatment;
^{($)}numbers in the same column with the same small letters are not statistically different (95% probability);

The results show that two weeks after the treatment time, sunburn had caused little damage in the untreated controls and that the preparations B and A had increased the sunburn damage significantly. This increase in the damage can be described as a herbicidal action. The higher the concentration of dispersion I in the preparations was set, the stronger was the herbicidal action.

Four weeks after the treatment date, all plots, even the untreated ones, were so severely damaged by sunburn that there was no longer any difference between treated and untreated. The trial also showed that the dissemination of plant diseases was neither promoted nor diminished by the preparations. The occurrence of the net blotch disease was the same on the flag leaf in all plots.

1. A preparation comprising at least one photocatalytically active metal oxide powder, wherein the specific surface area of the metal oxide powder is at least 20 m²/g and the preparation comprises at least one wetting agent.

2. The preparation according to claim 1, wherein the content of photocatalytically active metal oxide powder and wetting agent mutually independently is 0.001 to 70 wt. %, based on the preparation.

3. The preparation according to claim 2, wherein the content of photocatalytically active metal oxide powder is 25 to 50 wt. %.

4. The preparation according to claim 2, wherein the content of photocatalytically active metal oxide powder is 0.02 to 5 wt. % and that of wetting agent 0.001 to 2 wt. %.

5. The preparation according to claim 1, wherein a mean particle diameter of the photocatalytic-ally active metal oxide powder in the preparation is smaller than 1000 nm.

6. The preparation according to claim 1, wherein the photocatalytically active metal oxide powder is in the form of aggregated primary particles.

7. The preparation according to claim 1, wherein the photocatalytically active metal oxide powder has no internal surface.

8. The preparation according to claim 1, wherein the photocatalytically active metal oxide powder is a titanium dioxide powder, a zinc oxide powder, a mixed oxide powder with the components Ti, Zn, Al and/or Si, a crystal lattice-doped titanium oxide powder or zinc oxide powder and/or a surface-modified titanium dioxide powder or zinc oxide powder.

9. The preparation according to claim 1, wherein the titanium dioxide content has a rutile phase and an anatase phase.

10. The preparation according to claim 1, wherein the wetting agent is a superspreading agent.

11. The preparation according to claim 10, wherein the superspreading agent is a polysiloxane of the general formula
R₃—Si—[OSiRR¹]ₙ—O—SiR₃
wherein
R is an alkyl residue with 1 to 6 carbon atoms
R¹ has the structure Z—O—R² and Z is a divalent, optionally branched alkylene residue with 2 to 6 carbon atoms in the alkylene chain,
R² is a residue of the formula (CₘH₂ₘO—)ₛR³, wherein m is a number>2.0 and ≦2.5, s is a number from 4 to 21 and
R³ is a hydrogen residue, an alkyl residue with 1 to 4 carbon atoms or an acetyl residue, and
n is a number from 1 to 4.

12. The preparation according to claim 1, wherein the preparation further comprises additives usual for the stabilization of dispersions.

13. A process for the production of the preparation according to claim 1, comprising:
adding together with stirring
a dispersion with a photocatalytically active metal oxide powder content of up to 75 wt. %, which can optionally be stabilized by addition of pH regulators or surfactant substances, and
a wetting agent and optionally water,
until the desired content of metal oxide powder and wetting agent is in the range from 0.001 to 70 wt. %.

14. (canceled)

15. A method of weed control comprising applying the preparation according to claim 1 to an above-ground part of a plant.
